(19) United States
(12) Patent Application Publication
(10) Pub. No.: US 2018/0089460 A1
(43) Pub. Date: Mar. 29, 2018

(54) PATIENT-CENTERED VEHICLE EMERGENCY APPLICATION AND WEB INTERFACE THAT PROVIDES EMERGENCY PERSONNEL WITH VEHICLE DATA AND PERSONALIZED OCCUPANT HEALTH INFORMATION

(71) Applicant: FORD GLOBAL TECHNOLOGIES, LLC, Dearborn, MI (US)

(72) Inventors: Austin S. KIRK, Sterling Heights, MI (US); Hussein F. NASRALLAH, Dearborn Heights, MI (US); David Anthony HATTON, Berkley, MI (US); Fuyi WANG, Royal Oak, MI (US); Nicholas FRISCH, Chicago, IL (US); Robert A. KELLER, Hermosa Beach, CA (US); Stephen BARTOL, Windsor (CA)

(21) Appl. No.: 15/645,154

(22) Filed: Jul. 10, 2017

Related U.S. Application Data
(60) Provisional application No. 62/398,862, filed on Sep. 23, 2016.

(51) Int. Cl. G06F 21/62; G08B 25/10; H04L 29/06; G07C 5/08; G07C 5/00

(52) U.S. Cl. CPC G06F 21/6245; G08B 25/10; H04L 67/10; G07C 5/085; G07C 5/008; H04L 63/08

(57) ABSTRACT

A mobile device stores medical credentials for one or more occupants of a vehicle. Responsive to receipt of an indication of an emergency event at the vehicle, the mobile device sends the credentials, an authentication code, and vehicle information to a cloud server to cause the cloud server to construct web content including the vehicle information and medical information accessible using the credentials. The mobile device also sends a link to the cloud server including the authentication code to an emergency dispatch.

### CROSS-REFERENCE TO RELATED APPLICATIONS

This application claims the benefit of U.S. provisional application Ser. No. 62/398,862 filed Sep. 23, 2016, the disclosure of which is hereby incorporated in its entirety by reference herein.

### TECHNICAL FIELD

Aspects of the disclosure generally relate to a patient-centered vehicle emergency application and a web interface that provides emergency personnel with vehicle data and personalized occupant health information.

### BACKGROUND

In America, there are 3.9 million annual emergency room visits for motor vehicle injuries, accounting for 10% of all injury-related emergency room visits. Patients are commonly assisted and transported by emergency responders in an ambulance, the mode of transport to the emergency room 43% of the time. A significant number of Americans have pre-existing medical conditions (48%) or are taking a prescription drug (50% of all adults, 90% of seniors in some surveys). When emergency responders arrive on the scene of a motor vehicle accident, they often have limited, if any, information about the passengers involved. In many instances, the only information emergency responders have is a location, and in some cases a name of a person.

### SUMMARY

In one or more illustrative embodiments, a system includes a mobile device programmed to store medical credentials for one or more occupants of a vehicle, and responsive to receipt of an indication of an emergency event at the vehicle, send the credentials, an authentication code, and vehicle information to a cloud server to cause the cloud server to construct web content including the vehicle information and medical information accessible using the credentials, and send a link to the cloud server, including the authentication code, to an emergency dispatch.

In one or more illustrative embodiments, a method includes responsive to receipt of an indication of an emergency event at a vehicle, sending stored medical credentials for one or more occupants of the vehicle, an authentication code, and vehicle information from an in-vehicle communication device to a cloud server; and sending a link to the cloud server, including the authentication code, from the in-vehicle communication device to an emergency dispatch.

In one or more illustrative embodiments, a non-transitory computer-readable medium comprising instructions that, when executed by a processor of a mobile device, cause the mobile device to receive medical credentials for an occupant of a vehicle using a display of the mobile device; store the credentials to a storage of the mobile device; receive an indication of an emergency event at the vehicle over a local-area connection between the mobile device and the vehicle; send the credentials retrieved from the storage, an authentication code, and vehicle information to a cloud server to cause the cloud server to construct web content including the vehicle information and medical information accessible using the credentials, and send a link to the cloud server, including the authentication code, to an emergency dispatch to allow the emergency dispatch to access the vehicle information and medical information.

### BRIEF DESCRIPTION OF THE DRAWINGS

FIG. 1 illustrates an example system for providing patient medical information in an event of a motor vehicle emergency;

FIG. 2 illustrates an example schematic including the components of the system;

FIG. 3 illustrates an example process of operation of the system;

FIG. 4 illustrates an example user interface of the mobile device for entry of user credentials;

FIG. 5 illustrates an example user interface of the mobile device showing further aspects of entry of user credentials;

FIG. 6 illustrates an example user interface of the mobile device showing selection of different occupants;

FIG. 7 illustrates an example interface of the mobile device showing entry of information for another of the occupants;

FIG. 8 illustrates an example user interface of the mobile device showing further aspects of entry of user credentials for another of the occupants;

FIG. 9 illustrates an example user interface of a dispatch computing device receiving a text message;

FIGS. 10-15 illustrate an example web page displayed to the dispatch computing device; and

FIG. 16 illustrates an example emergency report displaying health information to the dispatch computing device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

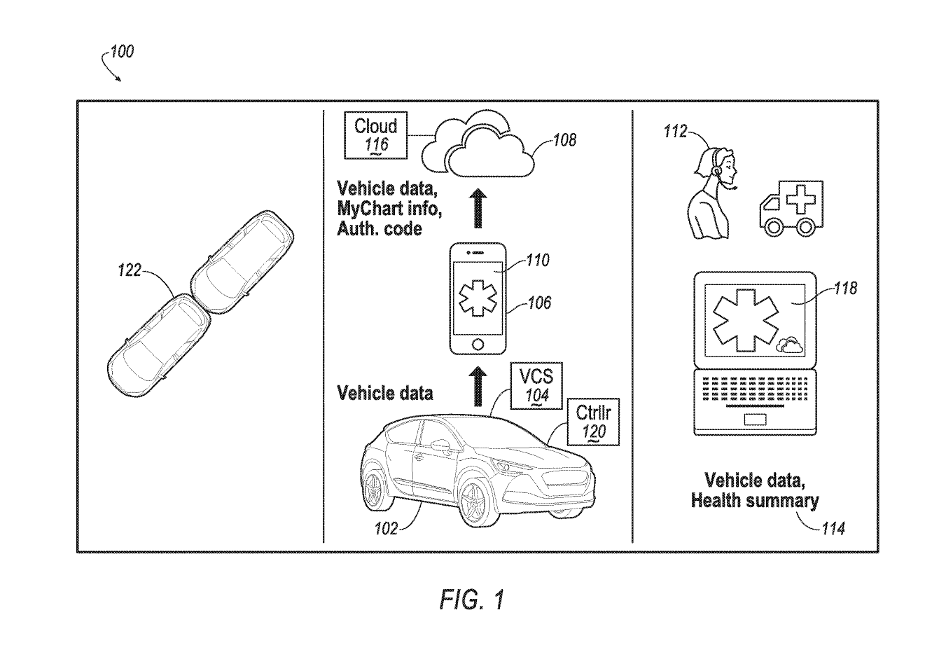

FIG. 1 illustrates an example system 100 for providing patient medical information in an event of a motor vehicle emergency. The system 100 includes a vehicle 102 having a vehicle computing system (VCS) 104. The VCS 104 is configured to communicate over a wide-area network 108 with a cloud-based system 116 using a mobile device 106. The system 100 also includes a patient-centered connectivity application 110 installed to the mobile device 106. In the event of a motor vehicle emergency 122, the patient-centered connectivity application 110 directs the mobile device 106 to provide emergency services with access to critical medical information of the vehicle occupants. The system 100 may be compliant with Health Insurance Portability and Accountability Act (HIPAA) regulations, which regulates how people access, discuss, and disseminate patient information. The system 100 may not also require approval from the United States Food and Drug Administration (FDA). While an example system 100 is shown in FIG. 1, the example components as illustrated are not intended to be limiting. Indeed, the system 100 may have more or fewer components, and additional or alternative components and/or implementations may be used. As one example, the patient-centered connectivity application 110 may be installed to a computing system of the vehicle 102 and may communicate using an embedded modem of the vehicle 102, rather than utilizing the processor and cellular transceiver of the mobile device 106.

The vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electric vehicle (PHEV), or a parallel/series hybrid electric vehicle (PSHEV).

The VCS 104 may be configured to support voice command and BLUETOOTH interfaces with the driver and driver carry-on devices, receive user input via various buttons or other controls, and provide vehicle status information to a driver or other vehicle 102 occupants. An example VCS 104 may be the SYNC system provided by FORD MOTOR COMPANY of Dearborn, Michigan.

The VCS 104 may further include various types of computing apparatus in support of performance of the functions of the VCS 104 described herein. In an example, the VCS 104 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, a processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc.

The VCS 104 may be configured to communicate with mobile devices 106 of the vehicle occupants. The mobile devices 106 may be any of various types of portable computing device, such as cellular phones, tablet computers, smart watches, laptop computers, portable music players, or other devices capable of communication with the VCS 104. As with the VCS 104, the mobile device 106 may include one or more processors configured to execute computer instructions, and a storage medium on which the computer-executable instructions and/or data may be maintained. In many examples, the VCS 104 may include a wireless transceiver (e.g., a Bluetooth® controller, a ZigBee® transceiver, a Wi-Fi transceiver, etc.) configured to communicate with a compatible wireless transceiver of the mobile device 106. Additionally or alternately, the VCS 104 may communicate with the mobile device 106 over a wired connection, such as via a USB connection between the mobile device 106 and a USB subsystem of the VCS 104.

The wide-area network 108 may include one or more interconnected communication networks such as the Internet, a cable television distribution network, a satellite link network, a local area network, a wide area network, and a telephone network, as some non-limiting examples. Using an embedded modem of the VCS 104 (or a mobile device 106 of the user connected to the VCS 104), the vehicle 102 may be able to send outgoing data from the vehicle 102 to network destinations on the wide-area network 108, and receive incoming data to the vehicle 102 from network destinations on the wide-area network 108. The embedded modem (or mobile device 106) may include a cellular modem or other network transceiver configured to facilitate communication over the wide-area network 108 between the vehicle 102 and other devices of the system 100.

The patient-centered connectivity application 110 may be one application included on the storage of the mobile device 106. The patient-centered connectivity application 110 may include instructions that, when executed by the processor of the mobile device 106, cause the mobile device 106 to connect emergency personnel 112 (e.g., dispatch operations, first responders, etc.) with medical information and post-crash vehicle information of a vehicle owner and/or occupant(s). This information may be referred to herein as vehicle emergency data set (VEDS) 114. The application 110 may also allow for access to the vital medical information of multiple passengers who commonly ride in the vehicle 102.

As shown, the application 110 is installed to the mobile device 106 of a vehicle occupant. In such examples, the mobile device 106 may connect to the VCS 104 via APPLINK, SmartDeviceLink, or another standard in-vehicle mobile application framework to allow the application 110 to interact with the vehicle 102. In other examples, the application 110 may be installed to the VCS 104 and/or may communicate to the cloud-based system 116 via an embedded modem (not shown) of the VCS 104 of the vehicle 102.

The cloud-based system 116 may include various types of computing apparatus, such as a computer workstation, a server, a desktop computer, a virtual server instance executed by a mainframe server, or some other computing system and/or device. As mentioned above, computing devices, such as the cloud-based system 116, generally include a memory on which computer-executable instructions may be maintained, where the instructions may be executable by one or more processors of the computing device. In some examples, the cloud-based system 116 may include a data store configured to store information such as VEDS data 114 for later viewing. The cloud-based system 116 may further include a web server configured to provide web or other content to dispatch computing devices 118, as discussed in detail below.

The restraint controller 120 may detect presence of an emergency event 122 at the vehicle 102, such as responsive to inputs from the restraint controller 120 indicating sharp deceleration or other unusual vehicle 102 operation. It should be noted that in other examples, sensors or controllers other than the restraint controller 120 may be utilized as the source of the emergency event 122. In another example, a stability controller may be a source of detection of an emergency event 122.

To set up the system 100, the vehicle owner simply enters their MyChart or other health portal login credentials into the application 110. If an emergency event 122 occurs, this data may be provided by the application 110 to the cloud-based system 116. This allows the cloud-based system 116 to utilize the login credentials to provide information from the user's health portal to the emergency personnel 112.

In an example, the restraint controller 120 may detect presence of an emergency event 122, and may inform the VCS 104. The VCS 104 may inform the application 110 that the emergency event 122 has occurred. Responsive to being informed, the application 110 may receive the stored credentials, and send the credentials, the VEDS data 114 (airbag deployment status, maximum change in velocity, etc.), and a unique authentication code to the cloud-based system 116. The application 110 may additionally sent a text message to the emergency (e.g., 911) personnel 112 including a web link (from which the emergency personnel 112 may retrieve and view this information using a dispatch computing device 118) along with the unique authentication code.

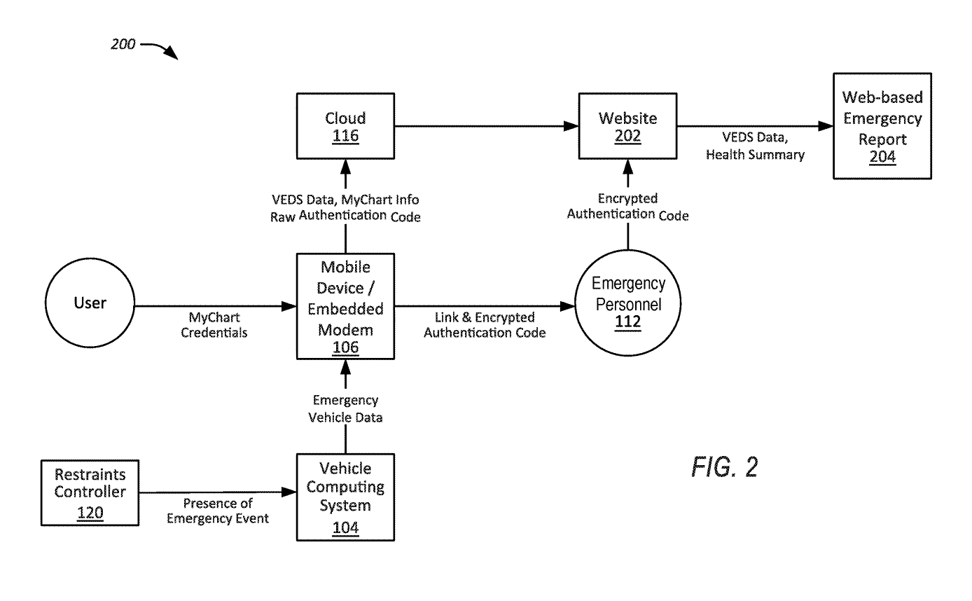

FIG. 2 illustrates an example schematic 200 including further details of aspects of operation of the system 100. As mentioned above, a user may enter his or her credentials into the application 110 executed by the mobile device 106 or into an application 110 of the embedded modem of the vehicle 102.

If an emergency event 122 is detected, the VCS 104 provides emergency vehicle data to the vehicle owner's mobile device 106 or to embedded modem of the vehicle 102. In an example, the emergency vehicle data may include the VEDS data 114 (e.g., airbag deployment status, maximum change in velocity, etc.) and health information.

Using the mobile device 106 or through an embedded modem of the vehicle 102, if so equipped, the VEDS data 114 and credentials may be provided to the cloud-based system 116. To preserve confidentiality, the information sent from the application 110 may be encrypted in this process, as indicated in the schematic 200 by the authentication codes. In some examples, to further add to the security of data traversing the network, support may be added to supply 911 operators/emergency personnel 112 with a physical token in the form of a USB dongle or to save the authentication code information directly to their individual dispatch computing devices 118.

The cloud-based system 116 may further provide a website 202 through which the VEDS data and MyChart information may be provided to the emergency personnel 112. From the website 202, the emergency personnel 112 may request a web-based emergency report 204 from the cloud-based system 116. The website 202 and web report 204 may be viewable on dispatch computing devices 118, which may include mobile devices as well as laptops or desktop computers.

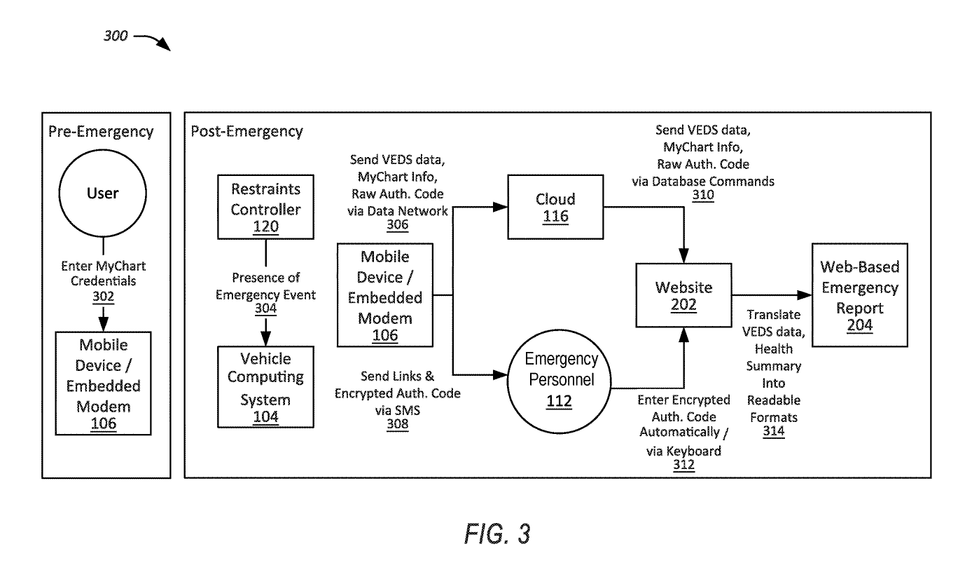

FIG. 3 illustrates an example process 300 of operation of the system 100. At 302, a user enters his or her MyChart credentials into the application 110 of the mobile device 106 or an embedded modem 106 of the vehicle 102. In an example, this entry may be done pre-emergency, for instance as part of setup of a vehicle 102 when it is purchased, to initialize the system 100 for use.

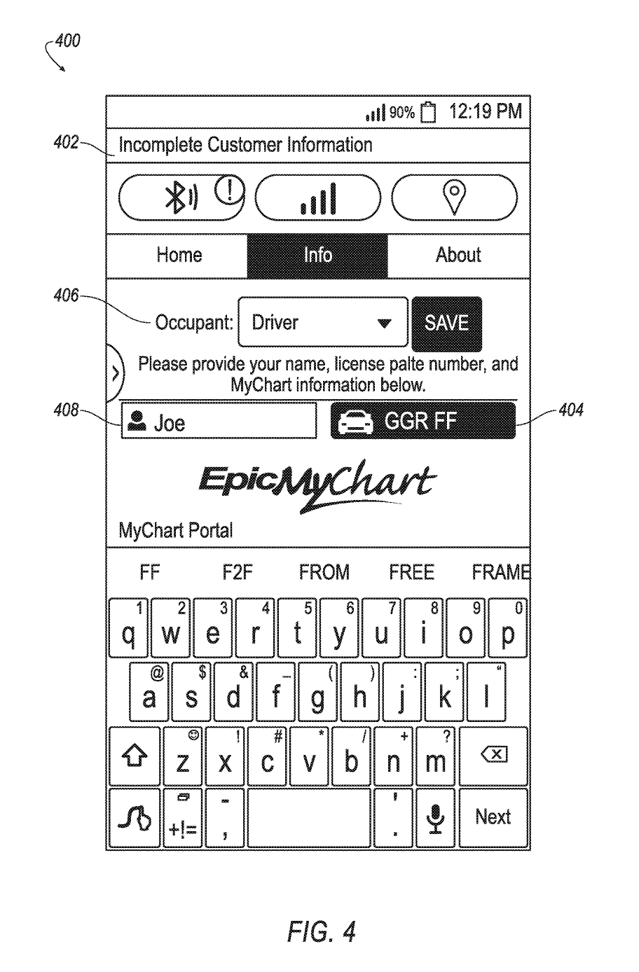

Referring to FIG. 4, a user interface 400 of the mobile device 106 for entry of user credentials is illustrated. As shown, the user interface 400 includes an indication 402 that the user's credential information has not been filled out, and a set of fields to be filled out. These fields include a license plate field 404 into which a user may enter a license plate number of the vehicle 102. The user interface 400 also includes an occupant selector control 406 from which the user can select whether the entered information is for the driver, or is for a typical passenger of the vehicle (e.g., passenger 1, passenger 2, passenger 3, etc.). The user interface 400 also includes a name field 408 into which the user can enter the name of the occupant selected from the occupant selector control 406. Once the information is input into the user interface 400, the user may select the save control 410 to save the information for later use.

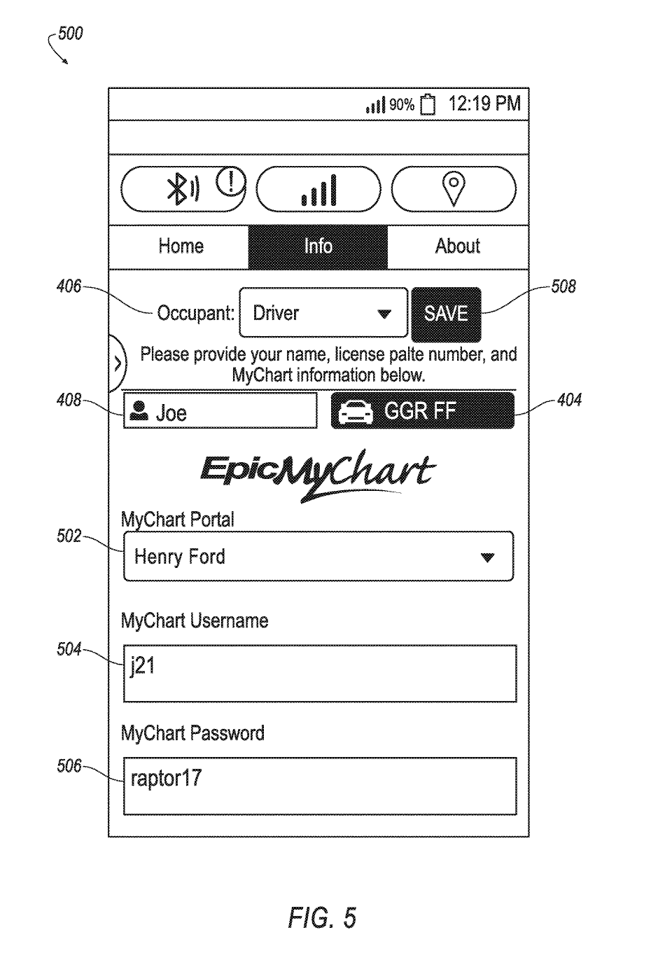

Referring to FIG. 5, further aspects of entry of user credentials is illustrated in a user interface 500 of the mobile device 106. As shown, the user interface 500 includes a chart selector control 502 from which the user may select from available medical information portals for which login credential for the occupant indicated in the name field 408 are being provided. The user interface 500 also includes fields into which the login credentials may be entered, such as a user name field 504 and a password field 506. Once the user has entered and saved the information, the save control 410 may change to an edit control 508, which may be selected by the user to modify the information that is input. Once changes are made, edit control 508 may again become the save control 410 that may be selected to apply the changes.

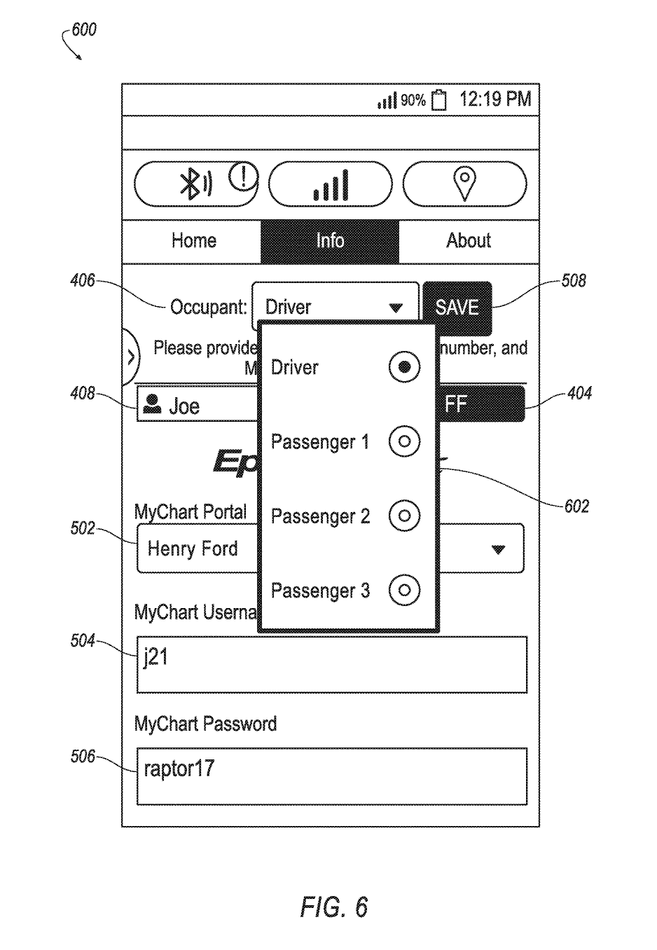

Referring to FIG. 6, a user interface 600 of the mobile device 106 is illustrated to show selection of different occupants. As shown, the occupant selector control 406 has been selected by the user, and is open to allow for selection to input credentials for other occupants of the vehicle 102. The user may select from the choices to enter information for another of the listed occupants.

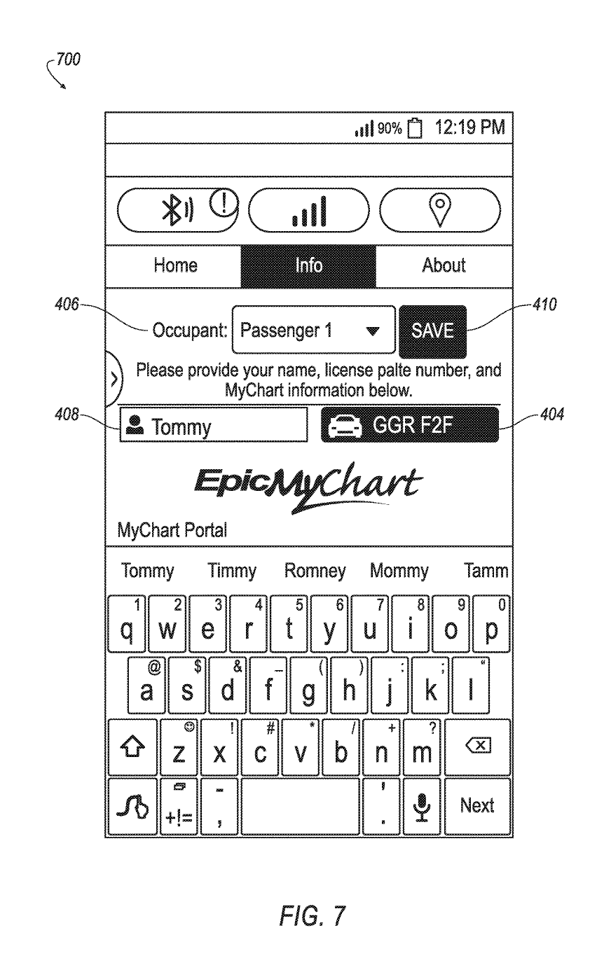

Referring to FIG. 7, a user interface 700 of the mobile device 106 is illustrated to show entry of information for another of the occupants. Similar to the user interface 400, the user may utilize the name field 408 (and other fields) to enter information for the other occupant, in this example, for passenger 1.

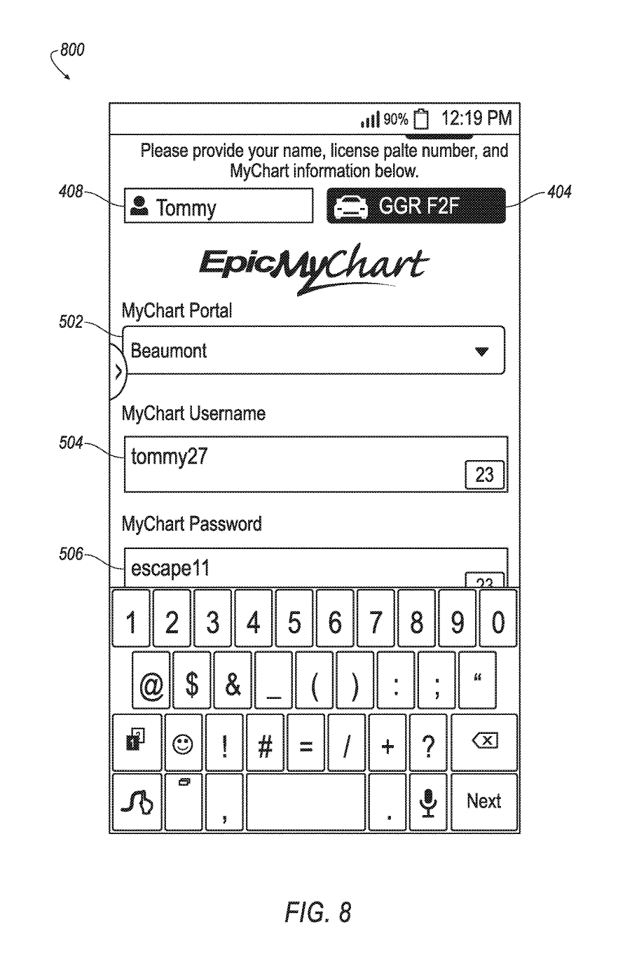

Referring to FIG. 8, further aspects of entry of user credentials for another of the occupants is illustrated in a user interface 800 of the mobile device 106. Similar to the user interface 500, the user may utilize the chart selector control 502, user name field 504, and password field 506 to enter information for the other occupant, in this example, for passenger 1. This entry process using the example user interfaces may be repeated until all users are entered and configured as desired by the user.

Referring back to FIG. 3, at 304 the restraints controller 120 (or other controller configured to provide emergency event 122 indications) indicates to the VCS 104 presence of an emergency event 122. This may occur, for example, responsive to acceleration, deceleration, or other sensor data indicative of a vehicle 102 emergency.

At 306, responsive to the indication at 304, the application 110 of the mobile device 106 or embedded modem 106 of the vehicle 102 sends the VEDS data 114, the credentials (e.g., MyChart data) entered pre-emergency, and a raw authentication code to the cloud-based system 116 via a cellular telephone or other data network.

At 308, also responsive to the indication at 304, the application 110 sends a link to the web site 202 and an encrypted authentication code to the emergency personnel 112 via text message, such as using short message service (SMS).

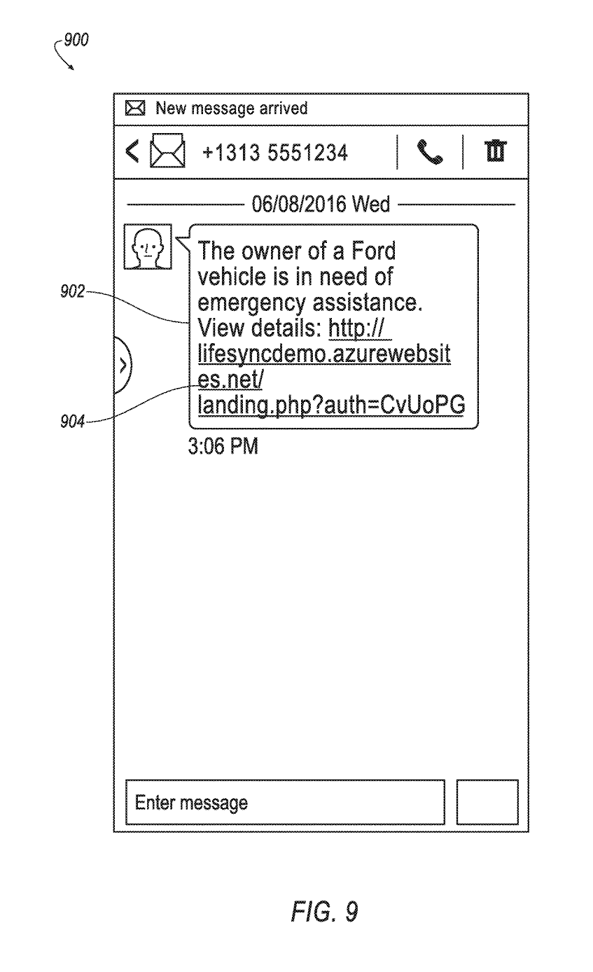

Referring to FIG. 9, a user interface of a dispatch computing device 118 receiving the text message 902 is illustrated. As shown, the text message 902 includes message text indicating that the sender of the message (e.g., the mobile device 106 of the user, the embedded modem of the vehicle 102, etc.) requires assistance. Also as shown, the message includes a link 904 that, when selected by emergency personnel 112 operating the dispatch computing device 118, causes the dispatch computing device 118 to navigate to the website 202. In some examples, the authentication code may be included in the link, e.g., as shown, the link indicates an authentication code of CvUoPG.

Referring back to FIG. 3, at 310 and also responsive to receiving the data from operation 306, the cloud-based system 116 constructs the website 202 including the VEDS data 114, the credentials of the occupants, and the raw authentication code using database commands. In an example, the website 202 may decode binary or encrypted aspects of the VEDS data 114 to provide a user-readable English (or other language) version of the contents.

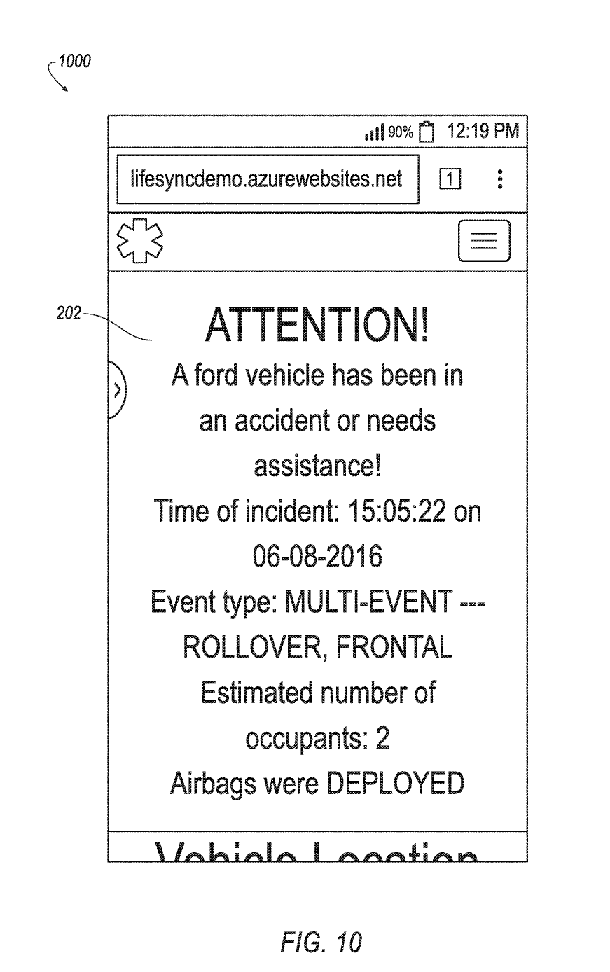

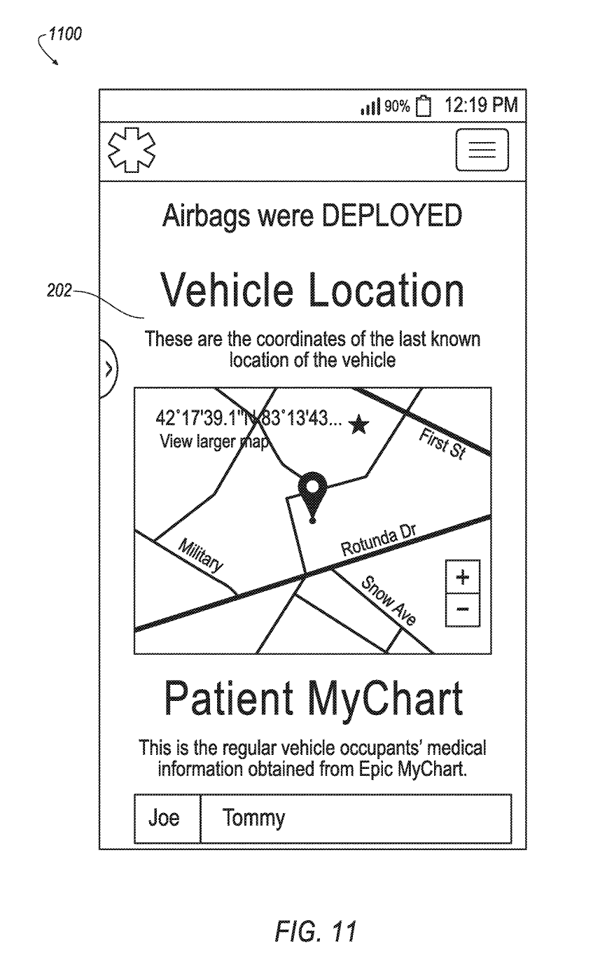

Referring to FIGS. 10-15, an example website 202 displayed to the dispatch computing device 118 is illustrated. FIG. 10 illustrates a portion 1000 of the website 202 providing general information regarding the emergency event 122. FIG. 11 illustrates a portion 1100 of the website 202 providing location information regarding the location of the emergency event 122 (e.g., decoded from the VEDS data 114).

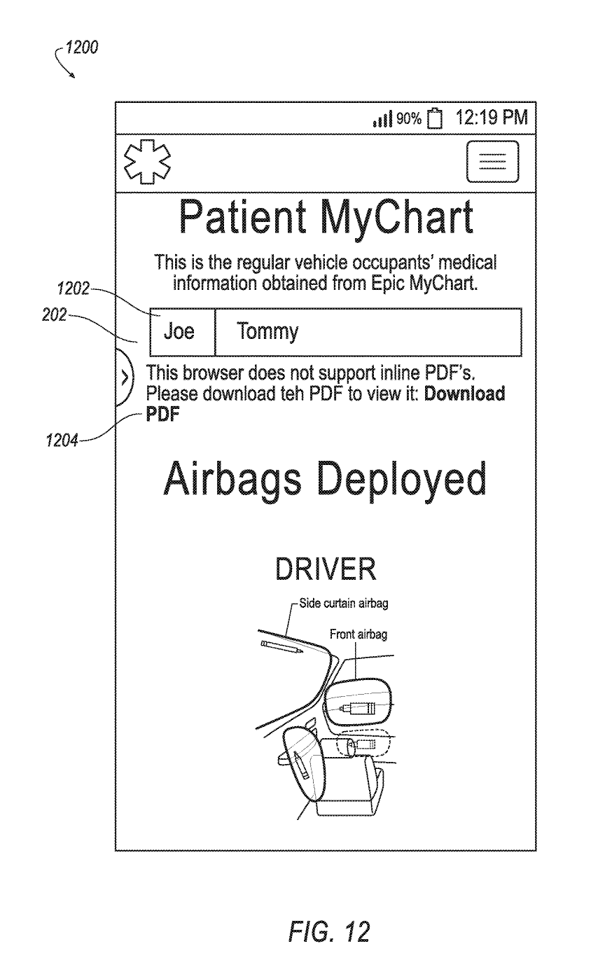

FIG. 12 illustrates a portion 1200 of the website 202 providing patient chart information accessed using the credentials of the user. In an example, for each of the occupants set up as described above, the website 202 includes a selection control 1202 (e.g., tabs) from which emergency reports 204 for each of the occupants (e.g., Joe, Tommy) may be downloaded and/or viewed. As shown, the Joe user is selected in the selection control 1202, and the download link 1204 provides a link to the emergency report 204 for Joe. In other examples, the emergency reports 204 may be provided in-line with the website 202, as a different possibility. The portion 1200 also includes airbag information (e.g., decoded from the VEDS data 114).

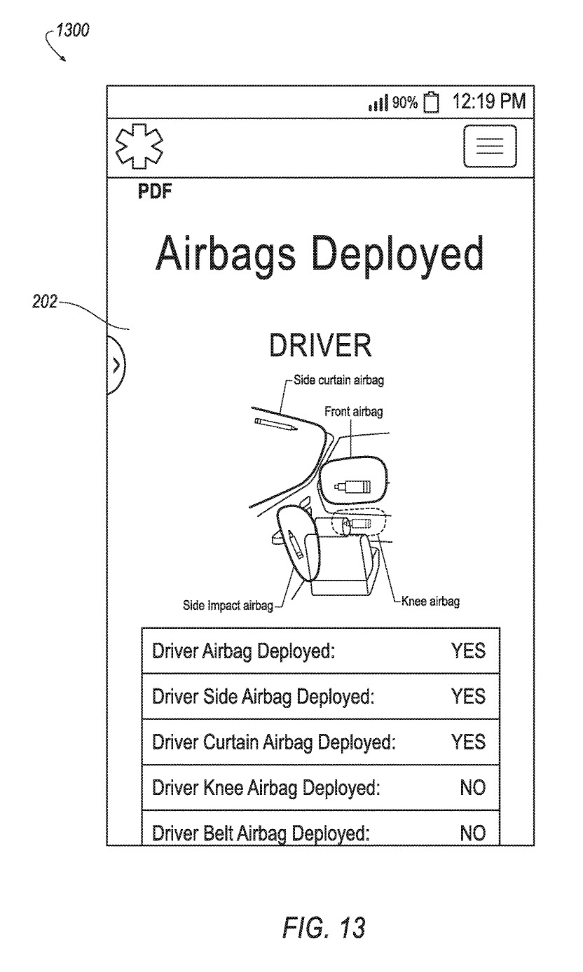

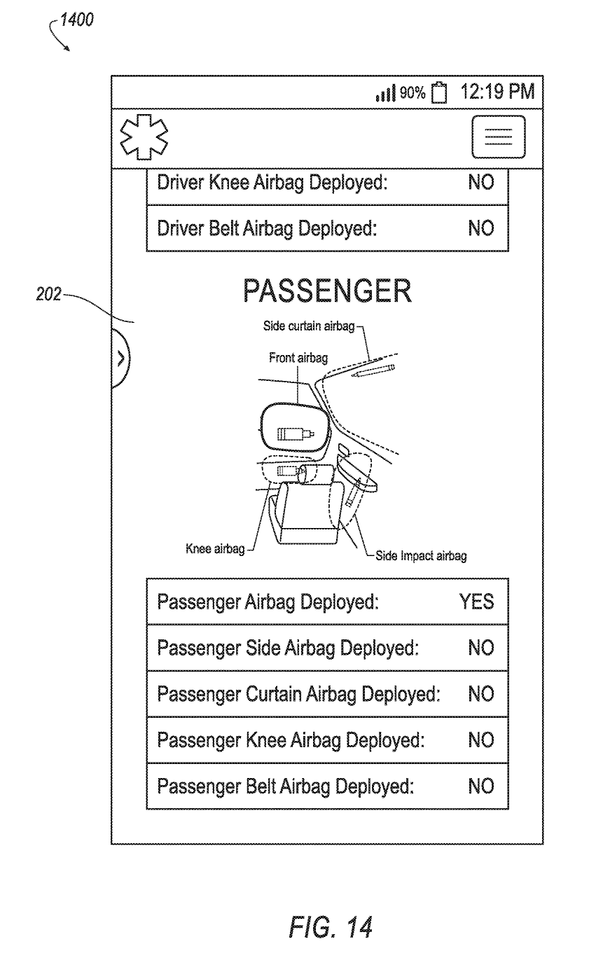

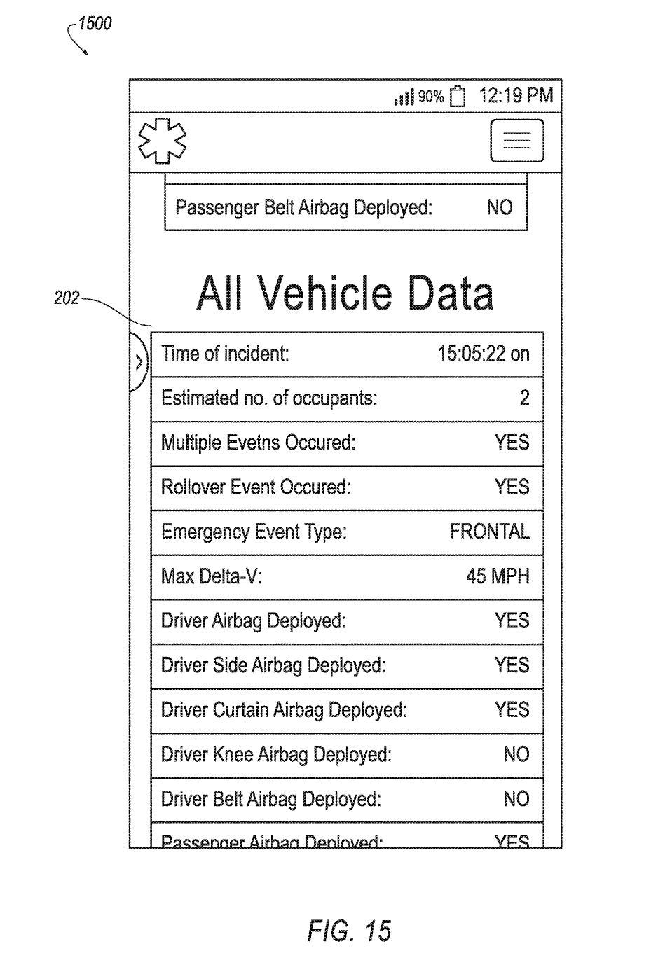

FIG. 13 illustrates a portion 1300 of the website 202 providing further airbag information for the driver. FIG. 14 illustrates a portion 1400 of the web site 202 providing airbag information for the front passenger. FIG. 15 illustrates a portion 1500 of the website 202 providing vehicle data regarding the emergency event 122. These aspects of information may also be decoded from the VEDS data 114.

Referring back to FIG. 3, at 312 the emergency personnel 112 uses the dispatch computing device 118 to follow the received link to view the website 202. Accordingly, VEDS data 114 and other information such as illustrated in the FIGS. 10-15 may be made available for viewing by the emergency personnel 112. In some examples (not shown), the dispatch computing device 118 may enter the encrypted authentication code automatically, e.g., based on its placement in the link. In other examples, the emergency personnel 112 may be provided access to the reported emergency event 122 via the website 202 provided using the authentication code. Additionally, the emergency personnel 112 may select the download link 1204 from the portion 1200 of the website 202 to view the emergency report 204.

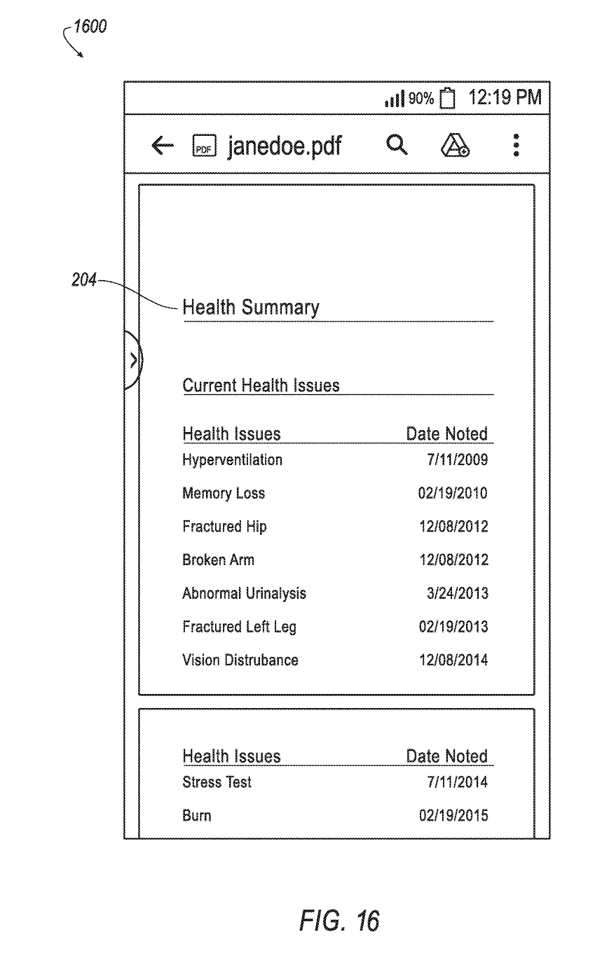

At 314, the cloud-based system 116 provides the web-based emergency report 204 including the health summary information for the occupants of the vehicle 102 into a user-readable format. FIG. 16 illustrates an example emergency report 204 displaying health information to the dispatch computing device. This health information may include, for example, past medical history of the occupants, medications prescribed to the occupants, allergies that the occupants may have, immunization records for the occupants, whether the occupants have preexisting conditions, and/or indications of past surgeries of the occupants (e.g., gallbladder removal, heart stent, hip replacement, etc.). This readable information may be provided to the emergency personnel 112 via the website 202 as a web-based emergency report 204. Using the report 204, the emergency personnel 112 may easily and securely access health information from occupants of the vehicle 102 having an emergency, on many types of computing device (e.g., phone, tablet, laptop, etc.).

By accessing the information in the web-based emergency report 204, emergency personnel 112, such as operators and responders, may be able to review health information (e.g., from MyCharts or other sources that may not otherwise be available), such as what prescriptions the occupants of the vehicle 102 are taking, what allergies that the occupants may have, and what pre-existing conditions the occupants may have. This information may allow the emergency personnel 112 to better treat the occupants, as such information may not be readily available at the scene of the emergency, especially if one or more of the occupants are unconscious.

Computing devices described herein, such as the VCS 104, mobile device 106, cloud-based system 116, and dispatch computing device 118, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a mobile device, programmed to store medical credentials for one or more occupants of a vehicle, and
responsive to receipt of an indication of an emergency event at the vehicle,
send the credentials, an authentication code, and vehicle information to a cloud server to cause the cloud server to construct web content including the vehicle information and medical information accessible using the credentials, and
send a link to the cloud server, including the authentication code, to an emergency dispatch.

2. The system of claim 1, wherein the mobile device is further programmed to receive the medical credentials from the one or more occupants of the vehicle as part of a setup procedure performed prior to the indication of the emergency event.

3. The system of claim 1, wherein the medical credentials provide access to medical records of the one or more occupants of the vehicle from a health portal.

4. The system of claim 1, wherein the indication of an emergency event at the vehicle is detected responsive to inputs from a restraints controller of the vehicle indicating vehicle deceleration.

5. The system of claim 1, wherein the indication of an emergency event at the vehicle is detected responsive to inputs from a stability controller of the vehicle.

6. The system of claim 1, wherein the vehicle information includes one or more of airbag deployment status or maximum change in velocity information.

7. The system of claim 1, wherein the medical information includes what prescriptions, allergies, and pre-existing conditions of the one or more occupants of the vehicle.

8. The system of claim 1, wherein the mobile device is a cellular phone.

9. The system of claim 1, wherein the mobile device is an embedded modem.

10. A method comprising:
responsive to receipt of an indication of an emergency event at a vehicle, sending stored medical credentials for one or more occupants of the vehicle, an authentication code, and vehicle information from an in-vehicle communication device from a mobile device to a cloud server; and
sending a link to the cloud server, including the authentication code, from the in-vehicle communication device to an emergency dispatch.

11. The method of claim 10, further comprising constructing, by the cloud server, web content including the vehicle information and medical information accessible using the credentials.

12. The method of claim 11, further comprising downloading the vehicle information and the medical information responsive to navigating a web browser to the link.

13. The method of claim 11, wherein the medical information includes what prescriptions, allergies, and pre-existing conditions of the one or more occupants of the vehicle.

14. The method of claim 10, further comprising decoding binary or encrypted aspects of the vehicle information by the cloud server to provide a user-readable version of the vehicle information for access via the link.

15. The method of claim 10, further comprising:
provide a user interface to a display of the mobile device to receive the medical credentials; and
storing the medical credentials to a storage of the mobile device.

16. A non-transitory computer-readable medium comprising instructions that, when executed by a processor of a mobile device, cause the mobile device to:
receive medical credentials for an occupant of a vehicle using a display of the mobile device;
store the credentials to a storage of the mobile device;
receive an indication of an emergency event at the vehicle over a local-area connection between the mobile device and the vehicle;
send the credentials retrieved from the storage, an authentication code, and vehicle information to a cloud server to cause the cloud server to construct web content including the vehicle information and medical information accessible using the credentials; and
send a link to the cloud server, including the authentication code, to an emergency dispatch to allow the emergency dispatch to access the vehicle information and medical information.

17. The medium of claim 16, further comprising instructions to cause the mobile device to receive the vehicle information from the vehicle responsive to the indication of the emergency event, the vehicle information including one or more of airbag deployment status or maximum change in velocity information.

18. The medium of claim 16, wherein the medical information includes one or more of past medical history of the occupant, medications prescribed to the occupant, allergies that the occupants may have, immunization records for the occupant, whether the occupant has a preexisting conditions, or indications of past surgeries of the occupant.

19. The medium of claim 16, wherein the mobile device is a cellular phone.

20. The medium of claim 16, wherein the mobile device is a controller of the vehicle in communication with an embedded modem.
